(19) United States
(12) Patent Application Publication
(10) Pub. No.: US 2009/0096209 A1
(43) Pub. Date: Apr. 16, 2009

(54) Flexible, self-bonding coupling assembly

(75) Inventor: Thomas Zilch, Los Angeles, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Transdigm, Inc.,

(21) Appl. No.: 11/907,174

(22) Filed: Oct. 10, 2007

(51) Int. Cl. F16L 55/00

(52) U.S. Cl. 285/80

(57) ABSTRACT

A self-bonding coupling assembly includes first and second portions operably connected by a hinge at a first end. The hinge preferably includes first and second hinge mechanisms that operate independently of one another. The coupling assembly also includes a fastening mechanism that releasably fastens the first coupling portion to the second coupling portion at a second end. The fastening mechanism uses extended portions provided on the first and second coupling portions to fasten the first and second coupling portions. The fastening mechanism includes first and second locking mechanisms. The first and second locking mechanisms include a latch that fastens the first and second coupling portions. The coupling assembly may also include a bonding mechanism and an indicator latch.

### FIELD OF THE INVENTION

The invention generally relates to coupling assemblies. More particularly, the invention relates to flexible coupling assemblies that are self-bonding and do not have a single point of failure.

### BACKGROUND OF THE INVENTION

Safety in transporting or moving fluids, such as fuel, through a conduit is important because of the pressure within the conduit, damage that may be caused by fluids leaking from the conduit, and the volatile and explosive nature of some fluids such as, for example, fuel. In the airplane industry, it is critical to ensure that fuel does not leak from a fuel transfer conduit because catastrophic results may occur.

It is often necessary to use multiple fuel transfer conduits to transport fuel from one location to another because of, for example, an indirect path that the fuel must follow to arrive at a desired location. In airplanes, for example, several fuel transfer conduits may be used to transport fuel from the airplane's fuel tanks to the engine. Since several fuel transfer conduits are needed to move fuel from the storage tank to the engine, couplings are needed to connect ends of the fuel transfer conduits to one another. Couplings and other devices have been designed to join fluid transfer conduits. It is critical that these couplings make a secure seal so that fuel does not leak because one area that is susceptible to leakage is the joint between two conduits. These couplings and other devices attempt to connect fuel transfer conduits such that there is a minimal risk of fuel escaping the fuel transfer conduit.

To lower the risk of leakage, the Federal Aviation Administration (FAA) has implemented Federal Aviation Regulation (FAR) 25. FAR 25 requires that certain couplings, such as those used to join fuel transfer conduits, incorporate two separate locking devices. Requiring two separate locking devices reduces a likelihood that a coupling will completely fail. This is because the coupling will not fail should only one of the locking devices fail. The coupling will remain closed by the remaining locking device.

Current couplings, however, have a single point of failure. That is, if one component of a coupling fails, even a minor component, the entire coupling fails and opens. This permits fluid from the conduit to leak and, in the case of fuel, cause devastating consequences. Additionally, current couplings do not meet the requirements of FAR 25 that couplings incorporate two separate locking devices.

Another disadvantage is that current couplings do not provide electrical bonding. For example, if a lightning strike travels to the coupling via a conduit connected to the coupling, there is no path that current from the lightning strike may follow through the coupling to an adjoining conduit and ultimately to a zero potential (ground) to avoid a fire. Additionally, current couplings enable static charge to accumulate in the conduits because of the fluid flowing through the conduits. This static charge may form a spark and ignite the fluid inside the conduits if the conduits are transporting a flammable fluid.

These and other disadvantages of current couplings exist.

### SUMMARY OF THE INVENTION

The foregoing disadvantages are overcome, to a great extent, by the present invention, wherein in one aspect of the invention, a coupling is provided that does not include a single point of failure. According to one embodiment of the invention, the coupling includes redundant features that eliminate single point failures. The invention also provides flexible couplings that are self-bonding and capable of withstanding a predetermined amount of pressure and angular misalignment. The self-bonding coupling includes first and second coupling portions, each having a first end and a second end. The first and second coupling portions include extended portions at each end. The first and second coupling portions are hinged at one end using the extended portions. According to one embodiment of the invention, each of the extended portions include a plurality of extended portions. The extended portions enable a hinge to operable connect the first coupling portion and the second coupling portion. Preferably, the hinge includes first and second hinge mechanisms that operate independently of each other.

According to another embodiment of the invention, a coupling assembly includes a fastening mechanism that fastens one end of each of the first coupling portion and the second coupling portion. The fastening mechanism preferably includes first and second locking mechanisms. The first and second locking mechanisms may include a latch operably connected to the first and second coupling portions using the extended portions. According to one embodiment, the latch is operably connected to the first and second couplings using a plurality of pins and is located between a plurality of extended portions.

According to another embodiment of the invention, the fastening mechanism also includes an indicator latch. The indicator latch preferably includes a biasing mechanism that maintains the indicator latch in an unlocked position. The indicator latch is held in a locked position when the first and second coupling portions are securely fastened. In this manner, the indicator latch indicates when the first and second coupling portions are securely fastened.

According to another embodiment of the invention, the coupling assembly includes a bonding mechanism. The bonding mechanism may be, for example, bond devices or bond wires. The bond devices may extend from a retention mechanism provided on each side of the first and second coupling portions. According to one embodiment, the bond devices are off-set from one another.

The bond wires may be substantially U-shaped and contact the first or second portion at a plurality of locations. The bond wires may also include a protruding portion. The protruding portion may be used to provide conductivity in certain applications.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top perspective view of a coupling assembly according to one embodiment of the invention.

FIG. 2 is a top perspective view of a fastening mechanism of a coupling assembly according to one embodiment of the invention.

FIG. 3 is a top perspective view of a latch of a coupling assembly according to one embodiment of the invention.

FIG. 4 is a top perspective view of a fastening mechanism of a coupling assembly according to one embodiment of the invention.

FIG. 5 is a top perspective view of a fastening mechanism of a coupling assembly according to one embodiment of the invention.

FIG. 6 is a top perspective view of a coupling assembly according to one embodiment of the invention.

FIG. 7 is a top perspective view of a coupling assembly according to one embodiment of the invention.

FIG. 8 is a top perspective view of a hinge of a coupling assembly according to one embodiment of the invention.

FIG. 9 is a top perspective view of a hinge of a coupling assembly according to one embodiment of the invention.

### DETAILED DESCRIPTION OF THE INVENTION

The invention will now be described with reference to the drawing figures, in which like reference numerals refer to like parts throughout. According to one embodiment of the invention, a flexible, self-bonding coupling is provided. The flexible, self-bonding coupling provides redundant features that eliminate single point failures.

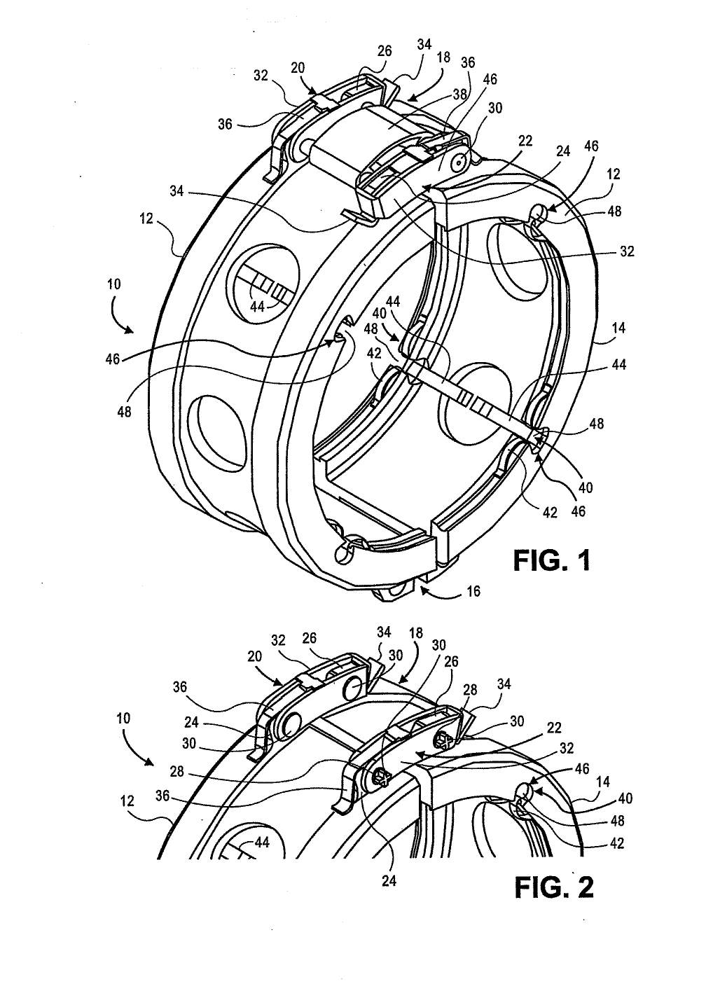

FIG. 1 illustrates a coupling 10 according to one embodiment of the invention. The coupling 10 includes a first portion 12 and a second portion 14. The first portion 12 and the second portion 14 are pivotably connected by a hinge 16 and releasably connected by a fastening mechanism 18. The fastening mechanism 18 may include a first locking mechanism 20 and a second locking mechanism 22. The first locking mechanism 20 and the second locking mechanism 22 may be connected to the first coupling portion 12 and the second coupling portion 14 using first extended portions 24 provided on the first coupling portion 12 and second extended portions 26 provided on the second coupling portion 14. The first extended portions 24 and the second extended portions 26 may included passages 28 (shown in FIG. 2) that receive pins 30 that operably connect the first locking mechanism 20 and the second locking mechanism 22 to the first coupling 12 and the second coupling portion 14, respectively.

According to one embodiment of the invention, the first locking mechanism 20 and the second locking mechanism 22 may include latches 32 that are pivotably connected to the first extended portions 24 and the second extended portions 26 by one of the pins 30 at one end of the latch. A tab 34 may be provided on another end of the latch to assist with opening of the latch 32. The tab 34 may be provided on an end of the latch 32 that is opposite the pin 30. The latch 32 may frictionally engage one end of the first extended portions 24 and the second extended portion 26. According to one embodiment of the invention, the latches 32 may face in opposite directions to provide a tighter seal for the coupling 10. The latches 32 may also include a latch spring 36 that assists in maintaining the latch 32 in a closed position.

The coupling 10 may also include an indicator latch 38. The indicator latch 38 may be pivotably connected about one end of the first locking mechanism 20 and the second locking mechanism 22. The indicator latch 38 may be operably connected to the first locking mechanism 20 and the second mechanism 22 by a pin 30 that extends from the first locking mechanism 20 to the second mechanism 22 via the passages 28. According to one embodiment of the invention, the indicator latch 38 closes into a locked position only when the first locking mechanism 20 and the second locking mechanism 22 secure the coupling 10 in a closed position.

The coupling 10 may also include a bonding mechanism 40 that enables the coupling 10 to be self-bonding and a latch spring 42. The latch spring 42 ensures that latch segments are engaged. The coupling 10 may also include a retention mechanism 46 that assists in enabling the coupling 10 to be self-bonding. The retention mechanism 46 may be, for example, a cut-out 48 provided in the first coupling portion 12 and the second coupling portion 14. The bonding mechanism 40 may be provided at one or more of the retention mechanisms 46. According to one embodiment of the invention, the elongated portions 44 of the bonding mechanism 40 may extend from the bonding mechanism 40 toward an inner portion of the coupling 10. The elongated portions 44 may align with the elongated portions 44 of the bonding mechanism 40 provided on a side opposite of the bonding mechanism 40.

FIG. 2 illustrates the fastening mechanism 18 shown in FIG. 1, however, the first locking mechanism 20 and the second locking mechanism 22 are positioned such that each locking mechanism is facing the same direction. Additionally, each of the latches 32 is provided with an independent pin 30 that is provided through each of the passages 28 in the first extended portion 24 and the second extended portion 26. It should be apparent to one of ordinary skill in the art that failure of either the first locking mechanism 20 or the second locking mechanism 22 will not cause the coupling 10 to open because the other locking mechanism will remain in a locked position. This provides a redundant coupling feature such that no single point of failure will cause the coupling 10 to open. For example, should the latch 32 of the second locking mechanism 22 open or one of the pins 30 of the first locking mechanism 20 break, this may cause the associated locking mechanism to fail. The other locking mechanism, however, will remain in a locked position, because no component of that locking mechanism has failed. Therefore, the coupling 10 is maintained in a closed position.

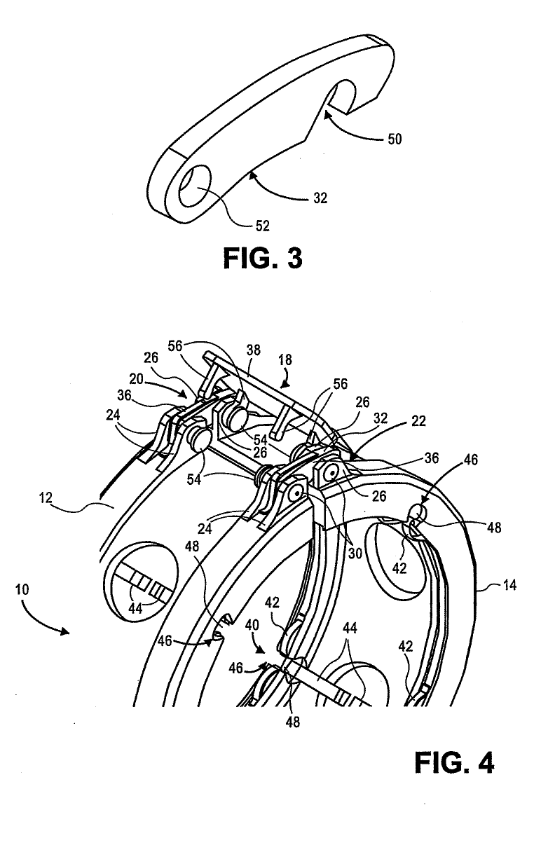

The latch 32 (as shown in FIG. 3) may be provided between extended portions of the first extended portion 24 and the second extended portion 26. The latch 32 may be provided with a receiving portion 50 and a securing portion 52. The receiving portion 50 may receive one of the pins 30 associated with the first locking mechanism 20 and the second locking mechanism 22, respectively. The securing portion 52 may be used to secure the latch 32 to another pin 30 associated with the first locking mechanism 20 and the second locking mechanism 22. The latch 32 enables the first coupling 12 and the second coupling portion 14 to be secured to one another and maintain the coupling 10 in a closed position.

FIG. 4 illustrates a coupling 10 according to one embodiment of the invention. The coupling 10 includes first locking mechanism 20 and a second locking mechanism 22 that include a plurality of pins 30 that enable a latch 32 to secure the first coupling portion 12 and the second coupling portion 14 to maintain the coupling 10 in a closed position. According to one embodiment, the pins 30 are provided with indicator latch receiving portions 54 that may be used to receive an indicator latch 38. Each pin 30 of the first locking mechanism 20 and the second locking mechanism 22 provided on either the first coupling portion 12 or the second coupling portion 14 may be pivotably connected to one or more of an indicator latch locking mechanism.

One or more indicator latch receiving portions 54 may be provided on the pins 30 of the first coupling portion 12 and the second extended portion 26 of the second coupling portion 14. The indicator latch 38 may include indicator latch mounting mechanisms 56 that releasably connect to the indicator latch receiving portions 54 on one end of the indicator latch 38 and are pivotably connected to the indicator latch receiving portions 54 at an opposite end of the indicator latch 38. The indicator latch 38 may be releasably locked in a closed position when the first locking mechanism 20 and the second locking mechanism 22 are each in a locked position. This enables a user to determine whether the coupling 10 is properly secured. If the indicator latch 38 is not in a locked position, this indicates that the coupling 10 is not in a locked or closed position.

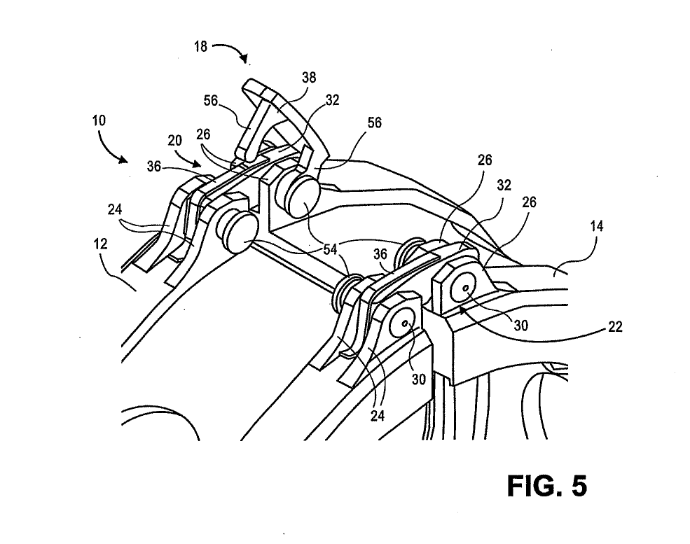

According to one embodiment of the invention, the indicator latch 38 may include a plurality of indicator latches 38 as shown in FIG. 5. An indicator latch 38 may be provided for each of the first locking mechanism 20 and the second locking mechanism 22. In this manner, a user may determine whether one or both of the first locking mechanism 20 and the second locking mechanism 22 are in a locked position and thus, whether the coupling is in a locked position.

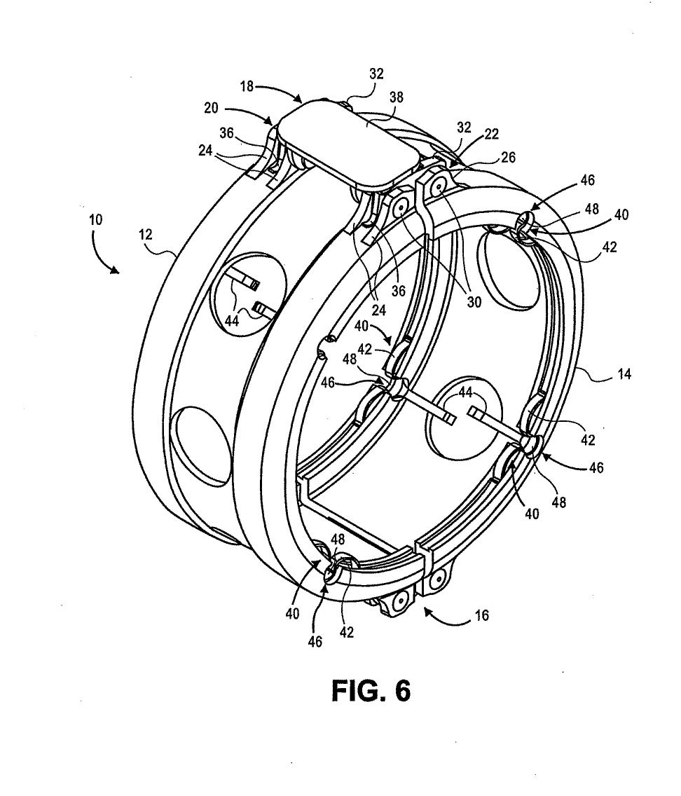

FIG. 6 illustrates a coupling 10 in a locked position according to one embodiment of the invention. The coupling 10 includes a bonding mechanism 40 that may be, for example, a bond device that includes elongated portions 44 that extend from one side of the coupling 10 toward a second side of the coupling 10. The coupling 10 may also include a bonding mechanism 40 positioned opposite a bond device provided on one side of the coupling 10 with an elongated portion 40 extended toward a center portion of the coupling 10. The bond devices 40 maybe staggered to avoid interference.

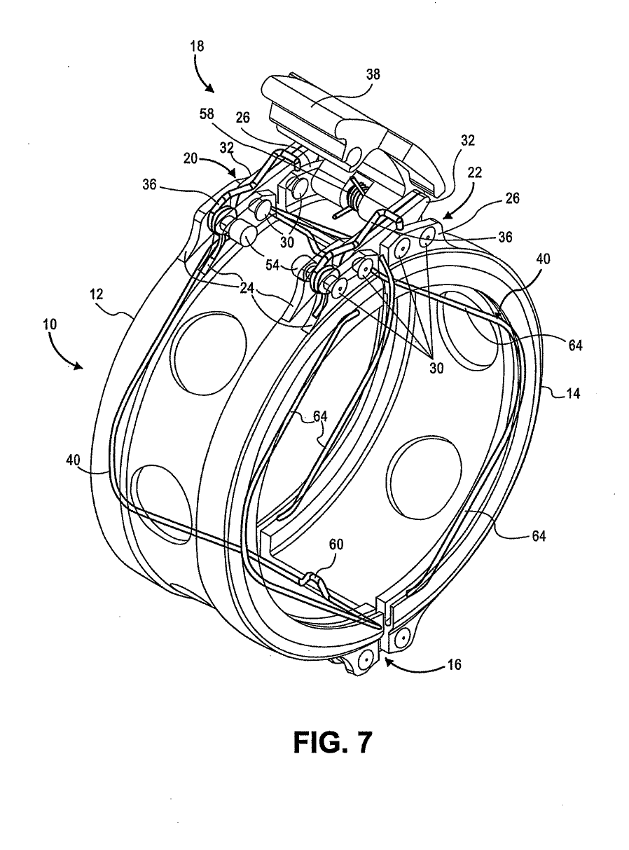

FIG. 7 illustrates a flexible self-bonding coupling 10 according to one embodiment of the invention. The coupling 10 includes a first coupling portion 12 and a second coupling portion 14. The first coupling portion 12 and the second coupling portion 14 are pivotably connected by a hinge 16. The coupling 10 also includes a fastening mechanism 18 that includes a first locking mechanism 20 and a second locking mechanism 22. The first locking mechanism 20 and second locking mechanism 22 are operably connected to first extended portions 24 provided on the first coupling 12 and to second extended portions 26 provided on the second coupling portion 14. The first extended portions 24 and the second extended portions 26 may include passages 28 through which pins 30 are provided. The latches 32 are secured to the first coupling portion 12 by the pins 30 and engaged to the second coupling portion 14 by the pins 30.

A latch spring 36 may be provided to lock the first locking mechanism 20 and the second locking mechanism 22 in a closed position. An indicator latch 38 may be pivotably connected to the pins 30 such that when the indicator latch 38 is in a closed position, this provides an indication that the first locking mechanism 20 and the second locking mechanism 22 are in a locked position. The indicator latch 38 may also include a biasing mechanism 58 that maintains the indicator latch 38 in an open position. In this manner a user may determine that the coupling is in an open position because the indicator latch 38 is in an open position.

The coupling 10 may also include a bonding mechanism 40. The bonding mechanism 40 may include a plurality of bond wires that are provided on one side of each of the first coupling portion 12 and the second coupling portion 14. According to one embodiment, the bond wires are substantially U-shaped and contact the first coupling portion 12 and the second coupling portion 14 at three (3) locations on each side of the first coupling portion 12 and the second coupling portion 14. The bond wires enable the coupling 10 to be self-bonding. One of the bond wires may extend from one side of the coupling 10 to another side of the coupling 10 and include a protruding portion 60. The protruding portion 60 may be used to provide conductivity to a standard sealing mechanism (sleeve) that may be used with the coupling 10. Portions 64 of the bond wire may also provide electrical bonding between two (2) conduits coupled by the coupling 10 and a standard sleeve typically used with such couplings. This provides protection against, for example, lightning strikes and static charge buildup.

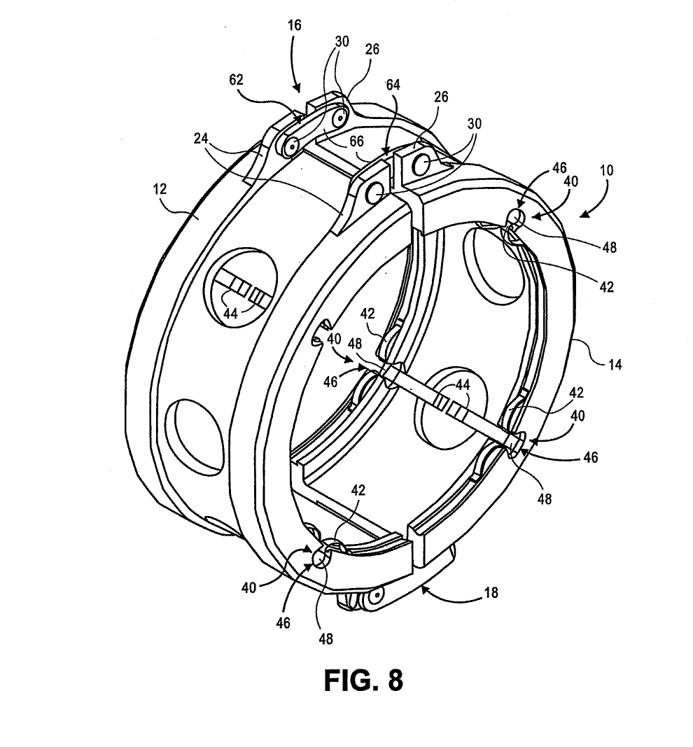

FIG. 8 illustrates a hinge 16 that may be used with a flexible, self-bonding coupling 10 according to the invention. The hinge 16 may include a first hinge mechanism 62 and a second hinge mechanism 64. Each of the first hinge mechanism 62 and a second hinge mechanism 64 preferably operate independent of each other. Thus, if either the first hinge mechanism 62 or the second hinged mechanism 64 should fail, the coupling 10 will remain in a closed position because the other hinge mechanism has not failed. The hinge 16 preferably pivotably connects the first coupling portion 12 and the second portion coupling 14 of the coupling 10 by securing a hinge member 66 to each of the first coupling portion 12 and the second coupling portion 14 using first extending portions 24 and second extended portions 26. Each of the first extended portions 24 and the second extended portions 26 may include passages through which pins are inserted and operably connect to the hinge member 66. In this manner, upon opening the coupling 10, each of the first coupling portion 12 and the second coupling portion 14 may pivot about pins 30 thus providing a flexible coupling 10.

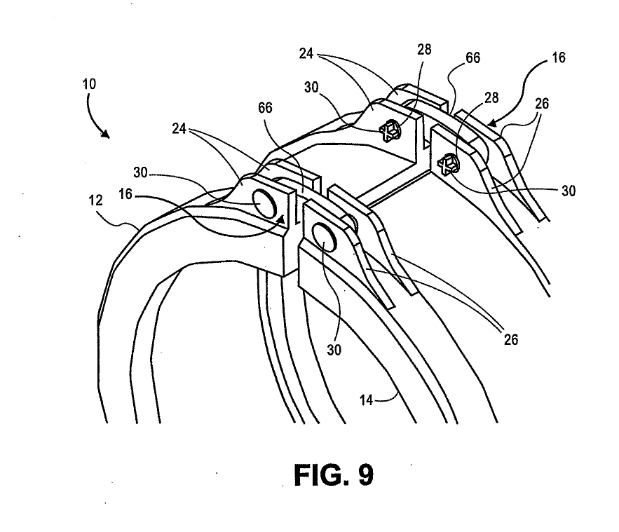

FIG. 9 illustrates hinges 16 for a coupling 10 according to one embodiment of the invention. The hinge 16 may be secured to the first coupling portion 12 and the second coupling portion 14 using the first extended portions 24 and the second extended portions 26 of the coupling 10. The first extended portions 24 and the second extended potions 26 include a plurality of extended portions. A hinge member 66 may be secured to the first extended portions 24 and the second extended portions 26 using the pins 30 that extend through the passages 28 in the first extended portions 24 and the second extended portions 26 and through passages provided in the hinge member 66.

Although an example of the coupling assembly is described in an aircraft environment, it will be appreciated that other environments can be used. Also, although the coupling assembly can be useful in other industries where similar functionality may be needed.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A coupling assembly comprising:
a first coupling portion operably connected to a second coupling portion at a first end to allow for opening and closing of the coupling assembly; and
a fastening mechanism configured to fasten the first coupling portion to the second coupling portion at a second end when the coupling assembly is in a closed position, wherein the fastening mechanism comprises:
a first locking mechanism configured to maintain the coupling assembly in the closed position; and
a second locking mechanism configured maintain the coupling assembly in the closed position.

2. The coupling assembly of claim 1 further comprising a first indicator latch configured to close into a locked position only when the first locking mechanism secures the first coupling portion to the second coupling portion.

3. The coupling assembly of claim 2, wherein the first indicator latch comprises a biasing mechanism configured to maintain the first indicator latch in an unlocked position until the first indicator latch is closed into the locked position.

4. The coupling assembly of claim 3, wherein the biasing mechanism comprises any one of a sheet metal latch spring and a torsion spring.

5. The coupling assembly of claim 2 further comprising a second indicator latch configured to close into a locked position only when the fastening mechanism secures the first coupling portion to the second coupling portion.

6. The coupling assembly of claim 1, wherein the first locking mechanism and the second locking mechanism operate independently of one another.

7. The coupling assembly of claim 1, wherein the first coupling portion comprises first extended portions and the second coupling portion comprises second extended portions.

8. The coupling assembly of claim 7, wherein either the first extended portions or the second extended portions comprise a plurality of extended portions.

9. The coupling assembly of claim 1, wherein the first locking mechanism comprises a first latch operably connected between one of the first extended portions and one of the second extended portions.

10. The coupling assembly of claim 9, wherein the first latch is operably connected to any one of the first extended portions and the second extended portions using a pin.

11. The coupling assembly of claim 1, wherein second locking mechanism comprises a second latch operably connected between one of the first extended portions and one of the second extended portions.

12. The coupling assembly of claim 11, wherein the second latch is operably connected to any one of the first extended portions and the second extended portions using a pin.

13. The coupling assembly of claim 1, wherein any one of the first locking mechanism and the second locking mechanism comprises a spring.

14. The coupling assembly of claim 1 further comprising a bonding mechanism configured to bond the coupling assembly to a device.

15. The coupling assembly of claim 14, wherein the bonding mechanism comprises any one of a bond device and a bond wire.

16. The coupling assembly of claim 15, wherein the bond wire contacts either of the first coupling portion and the second coupling portion at a plurality of locations.

17. The coupling assembly of claim 15, wherein the bond wire comprises a protruding portion.

18. The coupling assembly of claim 15, wherein each of the first coupling portion and the second coupling portion comprise a retention mechanism for the bond device.

19. The coupling assembly of claim 15, wherein the bond device comprises a plurality of bond devices, wherein each of the plurality of bond devices extend toward each other from one side of any one of the first coupling portion and the second coupling portion.

20. The coupling assembly of claim 19, wherein the plurality of bond devices are staggered.

21. The coupling assembly of claim 1, wherein the first coupling portion and the second coupling portion are operably connected using a hinge.

22. The coupling assembly of claim 21, wherein the hinge comprises a first hinge mechanism and a second hinge mechanism.

23. The coupling assembly of claim 22, wherein the first hinge mechanism and the second hinge mechanism operate independently of one another.

24. The coupling assembly of claim 22, wherein the first hinge mechanism and the second hinge mechanism are operably connected to the first coupling portion and the second coupling portion using extended portions provided on the first coupling portion and the second coupling portion.

25. The coupling assembly of claim 24, wherein each of the extended portions comprise a plurality of extended portions.
